(19) United States
(12) Patent Application Publication
(10) Pub. No.: US 2024/0290514 A1
(43) Pub. Date: Aug. 29, 2024

(54) MICROFLUIDIC DEVICE AND SYSTEM FOR SEPARATING AND PURIFYING RADIOISOTOPES

(71) Applicant: BATTELLE SAVANNAH RIVER ALLIANCE, LLC, AIKEN, SC (US)

(72) Inventor: CHRISTOPHER A. SOBECKI, AIKEN, SC (US)

(21) Appl. No.: 18/588,293

(22) Filed: Feb. 27, 2024

Related U.S. Application Data
(60) Provisional application No. 63/487,388, filed on Feb. 28, 2023.

(51) Int. Cl. G21G 1/02; B01D 59/24

(52) U.S. Cl. CPC G21G 1/02; B01D 59/24

(57) ABSTRACT

In one aspect, a microfluidic device, system, and method for separating and purifying radioisotopes is disclosed. The microfluidic device may comprise an inlet channel stream, an outlet channel stream, and a junction. The inlet channel stream, the outlet channel stream, and the junction may be in fluid communication.

### RELATED APPLICATIONS

The present application is based on and claims priority to U.S. Provisional Patent Application Ser. No. 63/487,388, filed on Feb. 28, 2023, which is incorporated herein by reference in its entirety.

### FEDERAL RESEARCH STATEMENT

This invention was made with government support under Contract No. 89303321CEM000080 awarded by the U.S. Department of Energy. The government has certain rights in the invention.

### FIELD

This present subject matter relates generally to separating and purifying radioisotopes, more particularly, to separating and purifying radioisotopes with microfluidic devices.

### BACKGROUND

Generally, the radioactive decay of radioisotopes, particularly medical radioisotopes, makes it challenging to purify, package, and ship the radioisotopes to medical treatment facilities at reasonable times. Notably, in modern times, there is a demand to increase the production of radioisotopes and to decrease the cost of producing the radioisotopes. However, the demand for radioisotopes is generally not being met as many countries are unable to increase production of the radioisotopes as a result of increased safety regulations of newly built research reactors, such as environmental regulations and workplace safety regulations.

To fulfill these economic and engineering challenges, microfluidic devices have been employed in various capacities to produce radioisotopes. However, the microfluidic devices may have limited efficacy based on the configuration of the microfluidic device itself, based on the system for purifying the radioisotopes, or based on the method of purifying the radioisotope. Thus, there is a need for an improved microfluidic device, system, and related methods for separating and purifying radioisotopes.

### SUMMARY OF THE INVENTION

Aspects and advantages of the invention will be set forth in part in the following description, or may be obvious from the description, or may be learned through practice of the invention.

In one aspect, the present subject matter is directed to a microfluidic device. The microfluidic device may include: two or more inlet channels, a first inlet channel of the two or more inlet channels having a first inlet channel junction angle of from about 10° to about 90°, the first inlet channel having a channel width of less than about 1 millimeter, the two or more inlet channels comprising two or more inlet channel streams, at least one inlet channel stream comprising one or more radioisotopes; an outlet channel, the outlet channel comprising an outlet channel stream; and a junction, the junction being in fluid communication with the two or more inlet channels and the outlet channel; wherein the two or more inlet channels are in fluid communication with the outlet channel.

In another aspect, the present subject matter is directed to a microfluidic device. The microfluidic device may include: two or more inlet channels, the two or more inlet channels comprising a first inlet channel, the first inlet channel having a channel width of less than about 1 millimeter, the two or more inlet channels comprising two or more inlet channel streams, the two or more inlet channel streams comprising a first inlet channel stream, the first inlet channel stream comprising a liquid, the two or more inlet channel streams comprising a second inlet channel stream, the second inlet channel stream comprising a gas, wherein at least one inlet channel stream comprises one or more radioisotopes; an outlet channel, the outlet channel comprising an outlet channel stream; and a junction, the junction being in fluid communication with the two or more inlet channels and the outlet channel; wherein the two or more inlet channels are in fluid communication with the outlet channel.

In yet another aspect, the present subject matter is directed to a system for separating and purifying radioisotopes. The system may include: a hot cell comprising one or more microfluidic devices, the one or more microfluidic devices comprising: two or more inlet channels, the two or more inlet channels comprising a first inlet channel, the first inlet channel having a channel width of less than about 1 millimeter, the two or more inlet channels comprising two or more inlet channel streams, the two or more inlet channel streams comprising a first inlet channel stream; one or more outlet channels, the one or more outlet channels comprising one or more outlet channel streams, the one or more outlet channel streams comprising a first outlet channel stream; and a junction; the junction being in fluid communication with the two or more inlet channels and the one or more outlet channels.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a microfluidic device in accordance with aspects of the present subject matter;

FIG. 2 illustrates a perspective view of one embodiment of a microfluidic device in accordance with aspects of the present subject matter;

FIG. 3 illustrates a perspective view of one embodiment of a microfluidic device in accordance with aspects of the present subject matter;

FIG. 4 illustrates a perspective view of one embodiment of a microfluidic device in accordance with aspects of the present subject matter; and

FIG. 5 illustrates a perspective view of one embodiment of a hot cell in accordance with aspects of the present subject matter.

Repeat use of reference characters in the present specification and drawings is intended to represent the same or analogous features or elements of the present invention.

### DETAILED DESCRIPTION

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

In general, the present disclosure is directed to a microfluidic device, related systems, and related methods for separating and purifying radioisotopes. The systems and methods disclosed herein for separating and purifying radioisotopes may include one or more microfluidic devices. A microfluidic device, system, or method disclosed herein for separating and purifying radioisotopes may have advantages compared to traditional radioisotope purification devices, systems, and/or methods, such as any of the advantages disclosed herein. A microfluidic device, system, or method disclosed herein may be utilized to separate and/or purify one or more radioisotopes, such as PET and/or non-PET radioisotopes. For instance, a microfluidic device, system, and/or method configured in accordance with the present disclosure may be utilized for the separation and/or purification of I-131, Co-60, Mo-99, Ir-192, Ra-223, Xe-133, Lu-177, Ac-225, or a combination thereof.

It should be understood that throughout the entirety of this specification, each numerical value (e.g., flow rate, concentration) disclosed should be read as modified by the term “about”, unless already expressly so modified, and then read again as not to be so modified. For instance, a value of “100” is to be understood as disclosing “100” and “about 100”. Further, it should be understood that throughout the entirety of this specification, when a numerical range (e.g., flow rate, concentration) is described, any and every amount of the range, including the end points and all amounts therebetween, is disclosed. For instance, a range of “1 to 100”, is to be understood as disclosing both a range of “1 to 100 including all amounts therebetween” and a range of “about 1 to about 100 including all amounts therebetween”. The amounts therebetween may be separated by any incremental value. Notably, some aspects of the present invention may omit one or more of the features disclosed herein.

Generally, one significant advantage of the microfluidic device of the present disclosure is that the heat transfer and mass transfer between different phases of matter, such as gas and liquid phases, is enhanced at least in part due to small-scale physics being typically heavily dependent on diffusion. With respect to gas and liquid phases, the heat and mass exchange between the two phases may be at least partially dependent on the flow rate, temperature, concentration, and pressure of one or more inlet channel streams and/or one or more outlet channel streams of a microfluidic device. Notably, an increase in the heat transfer and/or mass transfer between different phases of matter in a microfluidic device may increase radioisotope production and/or decrease waste, such as the waste associated with caustic solutions and/or a radioisotope.

Furthermore, a microfluidic device formed in accordance with the present disclosure may be highly integrable, cost-efficient, reusable, easily replaced or interchangeable, have a small footprint, or a combination thereof. Notably, the microfluidic device of the present disclosure may replace and/or supplement one or more hot cell components. In this respect, traditional hot cells generally require custom-made piping, custom-made traps, and other complex components. The microfluidic device of the present disclose may advantageously replace or supplement any of these components in a hot cell. Further, a microfluidic device formed in accordance with the present disclosure may shrink the size of a hot cell as a result of its advantageously small size. For instance, a hot cell including one or more microfluidic devices may have a height of less than about 5 meters, such as about 4 meters or less, such as about 3 meters or less, such as about 2 meters or less, such as about 1 meter or less. Generally, a hot cell including one or more microfluidic devices may have a width of less than about 5 meters, such as about 4 meters or less, such as about 3 meters or less, such as about 2 meters or less, such as about 1 meter or less. In general, a hot cell including one or more microfluidic devices may have a length of less than about 6 meters, such as about 5 meters or less, such as about 4 meters or less, such as about 3 meters or less, such as about 2 meters or less, such as about 1 meter or less.

In general, a microfluidic device, a system, and/or a method in accordance with the present disclosure may remove from about 80 wt. % to about 100 wt. % of impurities from a process stream in order to purify a radioisotope. For instance, a microfluidic device, a system, and/or a method in accordance with the present disclosure may remove about 80 wt. % or impurities or more, such as about 85 wt. % or more, such as about 90 wt. % or more, such as about 92 wt. % or more, such as about 95 wt. % or more, such as about 98 wt. % or more, such as about 100 wt. % or less, such as about 98 wt. % or less, such as about 95 wt. % or less, such as about 92 wt. % or less, such as about 90 wt. % or less. In general, a process stream may flow through and/or into one or more inlet channels of a microfluidic device.

In general, a microfluidic device may be configured to utilize liquid-gas extraction, liquid-liquid extraction, gas-gas extraction, gas-solid extraction, liquid-solid extraction, or a combination thereof. Notably, the gas utilized in a liquid-gas extraction, a gas-gas extraction, and/or a gas-solid extraction may comprise one or more radioisotopes, which may be referred to as one or more radioactive isotopes. For instance, the gas may comprise iodine-131, cobalt-60, molybdenum-99, iridium-192, radium-223, xenon-133, lutetium-177, actinium-225, calcium-47, carbon-11, carbon-14, chromium-51, cobalt-57, cobalt-58, erbium-169, fluorine-18, gallium-67, gallium-68, hydrogen-3, indium-111, iodine-123, iodine-125, iron-59, krypton-81, nitrogen-13, oxygen-15, phosphorus-32, rubidium-82, samarium-153, selenium-75, sodium-22, sodium-24, thallium-20, yttrium-90, or a combination thereof. In general, in some aspects, the liquid utilized in a liquid-gas extraction, liquid-liquid extraction, and/or liquid-solid extraction may comprise sodium hydroxide, hydrochloric acid, nitric acid, sulfuric acid, ethylenediaminetetraacetic acid, diethylenetriaminepentaacetic acid, ammonium sulfate, sodium sulfate, or a combination thereof. Notably, the liquid utilized may be in the form of a solution, such as a caustic solution. In some aspects, the liquid utilized in a liquid-gas extraction, liquid-liquid extraction, and/or liquid-solid extraction may comprise iodine-131, cobalt-60, molybdenum-99, iridium-192, radium-223, xenon-133, lutetium-177, actinium-225, calcium-47, carbon-11, carbon-14, chromium-51, cobalt-57, cobalt-58, erbium-169, fluorine-18, gallium-67, gallium-68, hydrogen-3, indium-111, iodine-123, iodine-125, iron-59, krypton-81, nitrogen-13, oxygen-15, phosphorus-32, rubidium-82, samarium-153, selenium-75, sodium-22, sodium-24, thallium-20, yttrium-90, or a combination thereof. In one aspect, a microfluidic device formed in accordance with the present disclosure may be utilized in a system and/or method to separate actinium-225 from radium-225 for medical applications. As previously disclosed herein, it should be understood that the one or more radioisotopes may include PET radioisotopes and/or non-PET radioisotopes.

Notably, a microfluidic device formed in accordance with the present disclosure may be a reusable microfluidic device or a single-use microfluidic device. In general, a single-use microfluidic device may be used to at least partially separate and/or purify a radioisotope and may be used as the packaging of the radioisotope. For instance, a liquid-gas extraction of a radioisotope may occur in the single-use microfluidic device. In this respect, one or more inlet channels may include one or more liquid inlet channel streams and one or more gas inlet channel streams. Then, the liquid of the liquid-gas outlet channel stream, which may contain the radioisotope, may be stored inside a reservoir of the single-use microfluidic device or a separate, second microfluidic device while the remaining gas escapes from the single-use microfluidic device. In some aspects, the gas of the outlet channel stream may flow toward a filter, such as a silver charcoal filter, that reduces the amount or prevents any amount of the radioisotope from being released into the atmosphere. Next, the one or more inlet channels and the one or more outlet channels of the single-use microfluidic device, or the second microfluidic device, may be sealed or capped and then the single-use microfluidic device or the second microfluidic device may be packaged in a container, such as a shielded container, for shipping.

Generally, a system incorporating a microfluidic device formed in accordance with the present disclosure may have two or more microfluidic devices in series and/or in parallel. In some aspects, a system incorporating a microfluidic device formed in accordance with the present disclosure may utilize clamps for the positioning or placement of a microfluidic device. Notably, one or more nozzles of a system may be placed in fluid communication with one or more inlet channels and/or one or more outlet channels of a microfluidic device. The one or more nozzles may introduce a process stream, such as a gas stream, a liquid stream, or a combination thereof, into one or more inlet channels of a microfluidic device. In general, the one or more nozzles may be removed and the one or more inlet channels and/or one or more outlet channels may be sealed or capped. In this respect, the sealing or capping of a microfluidic device may allow for the transportation of a microfluidic device containing a radioisotope. After a microfluidic device is removed from a system, another microfluidic device may positioned or placed in the system and replace the previous microfluidic device. Alternatively, a microfluidic device may be reusable and may be cleaned, as opposed to being removed.

In some aspects, a robotics system may be incorporated into a system formed in accordance with the present disclosure. Generally, a robotics system may be used to package a microfluidic device, replace a microfluidic device, attach one or more components, including any components disclosed herein, of a system (e.g., one or more microfluidic devices), or a combination thereof.

Generally, the microfluidic device and/or any component thereof may have an advantageous configuration. Notably, the microfluidic device may have one or more inlet channels and one or more outlet channels. The one or more inlet channels may comprise one or more inlet channel streams. The one or more outlet channels may comprise one or more outlet channel streams. The one or inlet channel streams and/or the one or more outlet channel streams may comprise a gas, a liquid, a solid, or a combination thereof.

In general, the microfluidic device and/or any component thereof (e.g., inlet channel, outlet channel) may comprise polydimethylsiloxane, a glass (e.g., pyrex, quartz, fused silica, alkali-free glass, soda lime glass), silicon, steel, a ceramic material, or a combination thereof. It should be understood that the microfluidic device and/or any component thereof may include a combination of one or more glasses and/or one or more ceramic materials. Notably, the aforementioned materials may be used for their ability to withstand high stresses. In this respect, the aforementioned materials may have a preferable Young's modulus. Further, the choice of the materials used in the microfluidic device and/or any component thereof may at least partially depend on the chemical compatibility of the material(s) with sodium hydroxide and/or sodium sulfate. In this respect, the choice of materials used in the microfluidic device and/or any component thereof may at least partially depend on the chemical compatibility of the material(s) with a caustic solution.

In some aspects, when glass (e.g., quartz) is utilized to form at least one component of the microfluidic device, the respective component of the microfluidic device may be treated with a silane (e.g., a long carbon chain) such that the silane anchors or attaches to the surface of the glass and makes the glass surface hydrophobic or hydrophilic. Notably, the glass surface may include at least some hydrophobic alkyl groups clustered together on the surface of the glass, which may develop a surface that may form and/or comprise micelles. Furthermore, by coating the surface of glass used in a microfluidic device, it may be protected from corrosion, such as from sodium hydroxide corrosion.

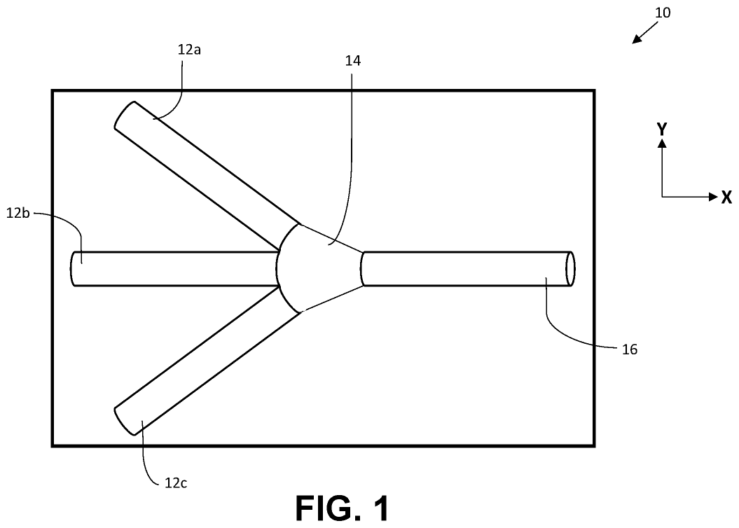

Generally, a microfluidic device may include one or more inlet channels, one or more outlet channels, one or more junctions, or a combination thereof. In general, one or more inlet channels, one or more outlet channels, one or more junctions, or a combination thereof of a microfluidic device may be in fluid communication. In some aspects, one or more inlet channels, one or more outlet channels, one or more junctions, or a combination thereof of a microfluidic device may be connected. Generally, the one or more inlet channels and/or one or more outlet channels may be connected to one or more converging junctions, one or more diverging junctions, one or more T-junctions, one or more Y-junctions, or a combination thereof. For instance, FIG. 1 illustrates a microfluidic device 10 comprising a Y-junction 14 connected to three inlet channels 12a, 12b, and 12c and one outlet channel 16. Notably, as illustrated in FIG. 1, the three inlet channels 12a, 12b, and 12c may be in fluid communication with the junction 14. Further, as illustrated in FIG. 1, the outlet channel 16 may be in fluid communication with the junction 14. In some aspects, inlet channels 12a and 12c may both include a gas inlet channel stream and inlet channel 12b may include a liquid inlet channel stream. In some aspects, the gas inlet channel streams of inlet channels 12a and 12c may include one or more radioisotopes and the liquid inlet channel stream of inlet channel 12b may include a caustic solution.

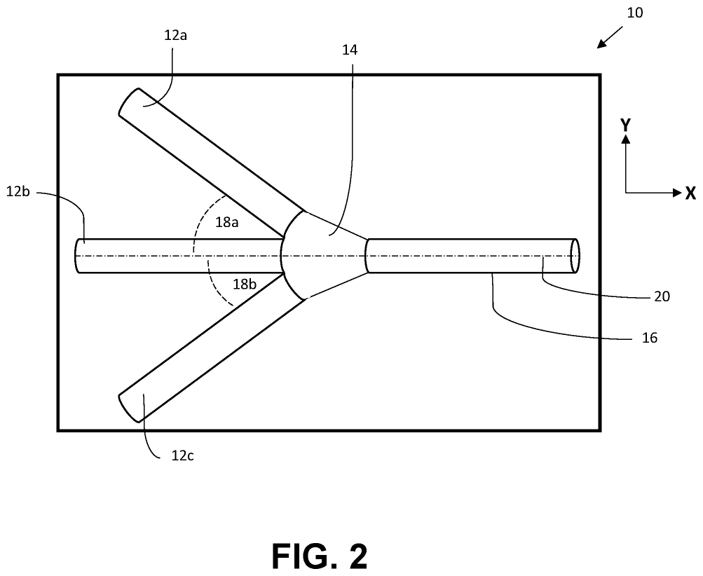

Notably, one or more inlet channels and/or one or more outlet channels may connect to a junction, such as a Y-junction and/or a T-junction. Generally, one or more inlet channels and/or one or more outlet channels may comprise one or more inlet channel junction angles and/or one or more outlet channel junction angles. In this respect, a channel junction angle is determined on the xy-plane, as illustrated in FIG. 2. As illustrated in FIG. 2, inlet channel junction angle 18a and inlet channel junction angle 18b are determined relative to the center axis 20 of the outlet channel 16 on the xy-plane. It should be understood that for a Y-junction or a T-junction, the center axis will be through the center of the channel that is singular. In this respect, a center axis may be through an inlet channel, if it is the only inlet channel, or an outlet channel, if it is the only outlet channel. Further, it should be understood that although center axis 20 of the outlet channel 16 aligns with the center axis of the inlet channel 12b in FIG. 2, the center axis of the inlet channel 12b is not utilized to determine the inlet channel junction angle 18a or the inlet channel junction angle 18b in FIG. 2 because the outlet channel 16 is the singular outlet channel of the Y-junction. In this respect, as the outlet channel 16 is the only outlet channel, the center axis 20 of the outlet channel 16 is utilized to determine the inlet channel junction angle 18a and inlet channel junction angle 18b.

Notably, a channel junction angle, such as an inlet channel junction angle and/or an outlet channel junction angle, may be from about 1° to about 90°, including all increments of 0.5° therebetween. For instance, an inlet channel junction angle and/or an outlet channel junction angle may be about 1° or more, such as about 10° or more, such as about 20° or more, such as about 30° or more, such as about 40° or more, such as about 50° or more, such as about 60° or more, such as about 70° or more, such as about 80° or more. In general, an inlet channel junction angle and/or an outlet channel junction angle may be about 90° or less, such as about 80° or less, such as about 70° or less, such as about 60° or less, such as about 50° or less, such as about 40° or less, such as about 30° or less, such as about 20° or less, such as about 10° or less.

In general, one or more junction angles, such as a first inlet channel junction angle and a second inlet channel junction angle, may be within 90° of each other, including all increments of 0.5° therebetween. For instance, a first inlet channel junction angle and a second inlet channel junction angle may be within 90° of each other, such as within 80° or less, such as within 70° or less, such as within 60° or less, such as within 50° or less, such as within 40° or less, such as within 30° or less, such as within 20° or less, such as within 10° or less, such as within 5° or less. In this respect, in one aspect, if a first inlet channel has a first inlet channel junction angle of 70° and a second inlet channel has a second inlet channel junction angle of 60°, the first inlet junction angle and the second inlet junction angle are within 10° of each other. In some aspects, for instance, a first outlet channel junction angle and a second outlet channel junction angle may be within 90° of each other, such as within 80° or less, such as within 70° or less, such as within 60° or less, such as within 50° or less, such as within 40° or less, such as within 30° or less, such as within 20° or less, such as within 10° or less, such as within 5° or less.

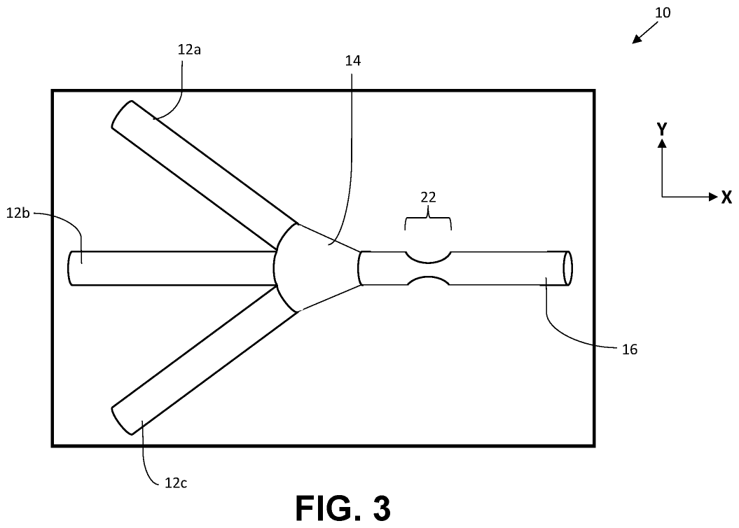

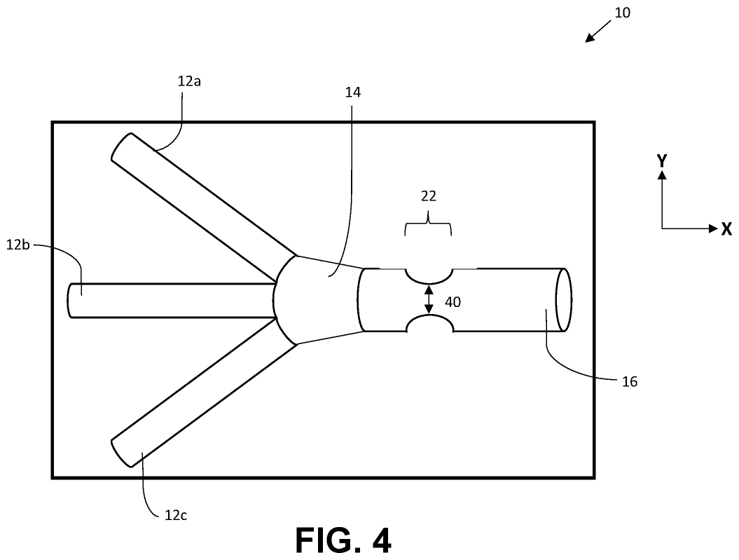

Generally, an inlet channel and/or an outlet channel may be cylindrical or rectangular. In some aspects, an inlet channel and/or an outlet channel may be a straight channel, a spiral channel, a curved channel (e.g., a serpentine channel, a sinusoidal channel), or a combination thereof. For instance, as illustrated in FIG. 3, inlet channels 12a, 12b, and 12c, and outlet channel 16 are straight, cylindrical channels. Notably, when an inlet channel and/or an outlet channel are cylindrical, the diameter of the respective channel may be constant or may vary. In this respect, in one aspect, the diameter of an inlet channel and/or an outlet channel may have one or more constriction portions that narrow the diameter of the channel. For instance, as illustrated in FIG. 3 and FIG. 4, an outlet channel 16 may have a throat 22 that narrows the diameter of the outlet channel 16 to a specific throat width or throat diameter 40.

Notably, an inlet channel and/or an outlet channel of the microfluidic device may have a channel width of from about 1 micron to about 1 millimeter, including all increments of 1 micron therebetween. For instance, an inlet channel and/or an outlet channel may have a channel width of about 1 micron or more, such as about 5 microns or more, such as about 10 microns or more, such as about 15 microns or more, such as about 20 microns or more, such as about 25 microns or more, such as about 30 microns or more, such as about 40 microns or more, such as about 50 microns or more, such as about 100 microns or more, such as about 150 microns or more, such as about 200 microns or more, such as about 300 microns or more, such as about 400 microns or more, such as about 500 microns or more. In general, an inlet channel and/or an outlet channel may have a channel width of about 1 millimeter or less, such as about 500 microns or less, such as about 400 microns or less, such as about 300 microns or less, such as about 200 microns or less, such as about 150 microns or less, such as about 100 microns or less, such as about 50 microns or less, such as about 40 microns or less, such as about 30 microns or less, such as about 25 microns or less, such as about 20 microns or less, such as about 15 microns or less, such as about 10 microns or less. Notably, when the inlet channel and/or the outlet channel of a microfluidic device is cylindrical, the aforementioned values may refer to the diameter of the channel. In this respect, an inlet channel and/or an outlet channel may have a channel diameter of from about 1 micron to about 1 millimeter, including all increments of 1 micron therebetween.

Generally, an inlet channel and/or an outlet channel of the microfluidic device may have a throat width of from about 1 micron to about 1 millimeter, including all increments of 1 micron therebetween. For instance, an inlet channel and/or an outlet channel may have a throat width of about 1 micron or more, such as about 5 microns or more, such as about 10 microns or more, such as about 15 microns or more, such as about 20 microns or more, such as about 25 microns or more, such as about 30 microns or more, such as about 40 microns or more, such as about 50 microns or more, such as about 100 microns or more, such as about 150 microns or more, such as about 200 microns or more, such as about 300 microns or more, such as about 400 microns or more, such as about 500 microns or more. In general, an inlet channel and/or an outlet channel may have a throat width of about 1 millimeter or less, such as about 500 microns or less, such as about 400 microns or less, such as about 300 microns or less, such as about 200 microns or less, such as about 150 microns or less, such as about 100 microns or less, such as about 50 microns or less, such as about 40 microns or less, such as about 30 microns or less, such as about 25 microns or less, such as about 20 microns or less, such as about 15 microns or less, such as about 10 microns or less. As used herein, the “throat” is the portion of an inlet channel and/or an outlet channel having a narrowed or expanded geometry as compared to the rest of the inlet channel and/or an outlet channel. For instance, as illustrated in FIG. 3, the throat 22 of the outlet channel 16 may have a narrowed geometry. It should be understood that the width of the throat refers to the narrowest width of the throat (i.e., the smallest width of the throat) for a throat having a narrowed geometry and refers to the most expanded width of the throat (i.e., the largest width of the throat) for a throat having an expanded geometry respectively. The throat of an inlet channel and/or an outlet channel may form liquid droplets, which may be at least partially dependent on the flow rate and/or the pressure within the microfluidic device. Notably, when the throat of an inlet channel and/or an outlet channel is cylindrical, the aforementioned values may refer to the diameter of the throat. In this respect, an inlet channel and/or an outlet channel may have a throat diameter of from about 1 micron to about 1 millimeter, including all increments of 1 micron therebetween. It should be understood that the diameter of the throat refers to the narrowest diameter of the throat (i.e., the smallest diameter of the throat) for a throat having a narrowed geometry and refers to the most expanded diameter of the throat (i.e., the largest diameter of the throat) for a throat having an expanded geometry respectively.

Notably, in some aspects, the throat width of an inlet channel and/or an outlet channel having a throat may be larger than the width of one or more inlet channels and/or one or more outlet channels of a microfluidic device. In general, the ratio of the throat width of an inlet channel and/or an outlet channel to an inlet channel width and/or an outlet channel width may be from about 40:1 to about 1:40, including all incremental ratios therebetween. For instance, the ratio of the throat width of an inlet channel and/or an outlet channel to an inlet channel width and/or an outlet channel width may be about 40:1 or less, such as about 30:1 or less, such as about 20:1 or less, such as about 15:1 or less, such as about 10:1 or less, such as about 5:1 or less, such as about 4:1 or less, such as about 3:1 or less, such as about 2:1 or less, such as about 1:1 or less, such as about 1:2 or less, such as about 1:3 or less, such as about 1:4 or less, such as about 1:5 or less, such as about 1:10 or less, such as about 1:15 or less, such as about 1:20 or less, such as about 1:30 or less. In general, the ratio of the throat width of an inlet channel and/or an outlet channel to an inlet channel width and/or an outlet channel width may be about 1:40 or more, such as about 1:30 or more, such as about 1:20 or more, such as about 1:10 or more, such as about 1:5 or more, such as about 1:4 or more, such as about 1:3 or more, such as about 1:2 or more, such as about 1:1 or more, such as about 2:1 or more, such as about 3:1 or more, such as about 4:1 or more, such as about 5:1 or more, such as about 10:1 or more, such as about 15:1 or more, such as about 20:1 or more, such as about 30:1 or more. Notably, when the throat and one or more inlet channels and/or one or more outlet channels are cylindrical, the aforementioned values may refer to the diameter of the throat and the one or more inlet channels and/or one or more outlet channels. In this respect, the ratio of the throat diameter of an inlet channel and/or an outlet channel to an inlet channel diameter and/or an outlet channel diameter may be from about 40:1 to about 1:40, including all incremental ratios therebetween.

In general, an inlet channel and/or an outlet channel may have a length from about 300 microns to about 10 cm, including all increments of 1 micron therebetween. Generally, an inlet channel and/or an outlet channel may have a length of about 300 microns or more, such as about 500 microns or more, such as about 1000 microns or more, such as about 5000 microns or more, such as about 1 cm or more. In general, an inlet channel and/or an outlet channel may have a length of about 10 cm or less, such as about 5 cm or less, such as about 1 cm or less, such as about 5000 microns or less, such as about 1000 microns or less. Notably, in some aspects, one or more inlet channels comprising one or more liquid inlet channel streams may be shorter in length than one or more inlet channels comprising one or more gas inlet channel streams.

Generally, an inlet channel may have an inlet channel stream flowing or moving therein. In general, an outlet channel may have an outlet channel stream flowing or moving therein. Notably, an inlet channel stream and/or an outlet channel stream may have a flow pattern of co-flows, threading, plugging, dripping, jetting, multi-satellite, or a combination thereof. In general, co-flows refers to the parallel movement of two or more immiscible fluids, from separate streams, that flow into the same channel without significant intermixing. Further, threading refers to the formation of threads of one fluid within another. Additionally, plugging refers to the formation of well-defined droplets of one fluid within another fluid. Notably, the well-defined droplets have a volume that occupies the entire width and/or height of a channel. In this respect, the droplets of a plugging flow pattern “plug” the channel. Further, multi-satellite refers to the formation of a plurality of smaller droplets, which may be referred to as satellites, around a larger, central droplet. In addition, dripping refers to when a fluid exits an opening, such as a nozzle, and continuously forms droplets that do not extend the entire width and/or height of a channel. In this respect, the droplets are surrounded by a fluid. Moreover, jetting refers to when a fluid exits an opening, such as a nozzle, in a continuous stream.

In some aspects, a channel (e.g., an outlet channel) may have a channel stream (e.g., an outlet channel stream) comprising a plurality of liquid droplets. Generally, the configuration and design of the channels, which include channel geometry, channel angle (e.g., inlet channel junction angle), and the configuration and design of the junction may influence the droplet size and/or the rate of droplet generation. In this respect, the configuration and design of the channels and/or the junction may be configured to influence the flow pattern, droplet size, and/or the rate of droplet generation. For instance, in a Y-junction having one outlet channel, an increase in the outlet channel width or outlet channel diameter may result in the decrease of a dripping portion or a plugging portion of the outlet channel stream. In this respect, the area of the outlet channel in which the flow pattern is dripping or plugging may decrease as the outlet channel width or outlet channel diameter increases. Further, for instance, the rate of droplet generation may increase as the throat width or throat diameter of an inlet channel and/or an outlet channel is decreased. Additionally, the average diameter of droplets may decrease as the throat width or throat diameter of an inlet channel and/or an outlet channel decreases.

In some aspects, the fluid pattern of an inlet channel stream and/or an outlet channel stream may include a plurality of liquid droplets. In general, the liquid droplets may have an average diameter from about 1 micron to about 150 microns, including all increments of 1 micron therebetween. For instance, the liquid droplets of an inlet channel stream and/or an outlet channel stream may have an average diameter of about 1 micron or more, such as about 10 microns or more, such as about 20 microns or more, such as about 30 microns or more, such as about 40 microns or more, such as about 50 microns or more, such as about 60 microns or more, such as about 80 microns or more. In general, the liquid droplets of an inlet channel stream and/or an outlet channel stream may have an average diameter of about 150 microns or less, such as about 100 microns or less, such as about 80 microns or less, such as about 60 microns or less, such as about 50 microns or less, such as about 40 microns or less, such as about 30 microns or less, such as about 20 microns or less, such as about 10 microns or less. Notably, the particle size distribution of droplets of an inlet channel stream and/or an outlet channel stream may be monomodal, bi-modal, and/or multi-modal. For instance, the droplets of an inlet channel stream or an outlet channel stream may have a multi-satellite fluid pattern that may have a bimodal or multimodal droplet size distribution.

In general, an inlet channel stream or an outlet channel stream that has a multi-satellite fluid pattern may have a liquid droplet size distribution such that at least a portion of the liquid droplet diameters range from about 1 micron to about 150 microns, including all increments of 1 micron therebetween. For instance, an inlet channel stream or an outlet channel stream that has a multi-satellite fluid pattern may have a liquid droplet size distribution such that at least a portion of the liquid droplet diameters are about 1 micron or more, such as about 10 microns or more, such as about 20 microns or more, such as about 30 microns or more, such as about 40 microns or more, such as about 50 microns or more, such as about 60 microns or more, such as about 80 microns or more. In general, an inlet channel stream or an outlet channel stream that has a multi-satellite fluid pattern may have a liquid droplet size distribution such that at least a portion of the liquid droplet diameters are about 150 microns or less, such as about 100 microns or less, such as about 80 microns or less, such as about 60 microns or less, such as about 50 microns or less, such as about 40 microns or less, such as about 30 microns or less, such as about 20 microns or less, such as about 10 microns or less.

Generally, an inlet channel stream and/or an outlet channel stream may comprise a gas. Notably, in some aspects, a gas inlet channel stream and/or a gas outlet channel stream may have a Reynolds number from about 0.5 to about 2000, including all increments of 0.5 therebetween. For instance, a gas inlet channel stream and/or a gas outlet channel stream may have a Reynolds number of about 0.5 or more, such as about 1 or more, such as about 50 or more, such as about 100 or more, such as about 200 or more, such as about 300 or more, such as about 400 or more, such as about 500 or more, such as about 1000 or more. In general, a gas inlet channel stream and/or a gas outlet channel stream may have a Reynolds number of about 2000 or less, such as about 1500 or less, such as about 1000 or less, such as about 500 or less, such as about 400 or less, such as about 300 or less, such as about 200 or less, such as about 100 or less, such as about 50 or less.

Notably, a gas inlet channel stream and/or a gas outlet channel stream may have a volumetric flow rate from about 0.001 mL/min to about 150 mL/min, including all increments of 0.001 mL/min therebetween. For instance, a gas inlet channel stream and/or a gas outlet channel stream may have a volumetric flow rate of about 0.001 mL/min or more, such as about 0.01 mL/min or more, such as about 0.1 mL/min or more, such as about 1 mL/min or more, such as about 5 mL/min or more, such as about 10 mL/min or more, such as about 15 mL/min or more, such as about 20 mL/min or more, such as about 30 mL/min or more, such as about 40 mL/min or more, such as about 50 mL/min or more, such as about 80 mL/min or more, such as about 100 mL/min or more. In general, a gas inlet channel stream and/or a gas outlet channel stream may have a volumetric flow rate of about 150 mL/min or less, such as about 100 mL/min or less, such as about 80 mL/min or less, such as about 50 mL/min or less, such as about 40 mL/min or less, such as about 30 mL/min or less, such as about 20 mL/min or less, such as about 15 mL/min or less, such as about 10 mL/min or less, such as about 5 mL/min or less, such as about 1 mL/min or less.

In general, a gas inlet channel stream and/or a gas outlet channel stream may have a temperature from about 0° C. to about 1500° C., including all increments of 1° C. therebetween. For instance, a gas inlet channel stream and/or a gas outlet channel stream may have a temperature of about 0° C. or more, such as about 100° C. or more, such as about 200° C. or more, such as about 300° C. or more, such as about 400° C. or more, such as about 500° C. or more, such as about 600° C. or more, such as about 700° C. or more, such as about 800° C. or more, such as about 900° C. or more, such as about 1000° C. or more. In general, a gas inlet channel stream and/or a gas outlet channel stream may have a temperature of about 1500° C. or less, such as about 1000° C. or less, such as about 900° C. or less, such as about 800° C. or less, such as about 700° C. or less, such as about 600° C. or less, such as about 500° C. or less, such as about 400° C. or less, such as about 300° C. or less, such as about 200° C. or less, such as about 100° C. or less.

Generally, a gas inlet channel stream and/or a gas outlet channel stream may have a radioisotope concentration of about 0 mCi/mL to about 150 mCi/mL, including all increments of 0.5 mCi/mL therebetween. For instance, a gas inlet channel stream and/or a gas outlet channel stream may have a radioisotope concentration of about 0 mCi/mL or more, such as about 20 mCi/mL or more, such as about 40 mCi/mL or more, such as about 60 mCi/mL or more, such as about 80 mCi/mL or more, such as about 100 mCi/mL or more, such as about 120 mCi/mL or more. In general, a gas inlet channel stream and/or a gas outlet channel stream may have a radioisotope concentration of about 150 mCi/mL or less, such as about 120 mCi/mL or less, such as about 100 mCi/mL or less, such as about 80 mCi/mL or less, such as about 60 mCi/mL or less, such as about 40 mCi/mL or less, such as about 20 mCi/mL or less.

In some aspects, a gas inlet channel stream and/or a gas outlet channel stream may have a pressure from about 5 kPa to about 50 kPa, including all increments of 1 kPa therebetween. For instance, a gas inlet channel stream and/or a gas outlet channel stream may have a pressure of about 5 kPa or more, such as about 10 kPa or more, such as about 15 kPa or more, such as about 20 kPa or more, such as about 30 kPa or more, such as about 40 kPa or more. In general, a gas inlet channel stream and/or a gas outlet channel stream may have a pressure of about 50 kPa or less, such as about 40 kPa or less, such as about 30 kPa or less, such as about 20 kPa or less, such as about 15 kPa or less, such as about 10 kPa or less.

Notably, a liquid inlet channel stream and/or a liquid outlet channel stream may have a volumetric flow rate from about 0.01 μL/min to about 20 mL/min, including all increments of 0.01 μL/min therebetween. For instance, a liquid inlet channel stream and/or a liquid outlet channel stream may have a volumetric flow rate of about 0.01 μL/min or more, such as about 0.1 μL/min or more, such as about 0.5 μL/min or more such as about 1 μL/min or more, such as about 2 μL/min or more, such as about 3 μL/min or more, such as about 4 μL/min or more, such as about 5 μL/min or more, such as about 6 μL/min or more, such as about 7 μL/min or more, such as about 8 μL/min or more, such as about 9 μL/min or more, such as about 10 μL/min or more, such as about 15 μL/min or more, such as about 1 mL/min or more, such as about 5 mL/min or more, such as about 10 mL/min or more. In general, a liquid inlet channel stream and/or a liquid outlet channel stream may have a volumetric flow rate of about 20 mL/min or less, such as about 15 mL/min or less, such as about 10 mL/min or less, such as about 5 mL/min or less, such as about 1 mL/min or less, such as about 15 μL/min or less, such as about 10 μL/min or less, such as about 9 μL/min or less, such as about 8 μL/min or less, such as about 7 μL/min or less, such as about 6 μL/min or less, such as about 5 μL/min or less, such as about 4 μL/min or less, such as about 3 μL/min or less, such as about 2 μL/min or less, such as about 1 μL/min or less. Notably, when the flow pattern of a channel includes liquid droplets, an increase in the liquid volumetric flow rate may increase the average liquid droplet diameter.

In general, a liquid inlet channel stream and/or a liquid outlet channel stream may have a temperature from about 0° C. to about 150° C., including all increments of 1° C. therebetween. For instance, a liquid inlet channel stream and/or a liquid outlet channel stream may have a temperature of about 0° C. or more, such as about 20° C. or more, such as about 40° C. or more, such as about 60° C. or more, such as about 80° C. or more, such as about 100° C. or more. In general, a liquid inlet channel stream and/or a liquid outlet channel stream may have a temperature of about 150° C. or less, such as about 100° C. or less, such as about 80° C. or less, such as about 60° C. or less, such as about 40° C. or less, such as about 20° C. or less.

Generally, a liquid inlet channel stream and/or a liquid outlet channel stream may have a radioisotope concentration of about 0 mCi/mL to about 150 mCi/mL, including all increments of 0.5 mCi/mL therebetween. For instance, a liquid inlet channel stream and/or a liquid outlet channel stream may have a radioisotope concentration of about 0 mCi/mL or more, such as about 20 mCi/mL or more, such as about 40 mCi/mL or more, such as about 60 mCi/mL or more, such as about 80 mCi/mL or more, such as about 100 mCi/mL or more, such as about 120 mCi/mL or more. In general, a liquid inlet channel stream and/or a liquid outlet channel stream may have a radioisotope concentration of about 150 mCi/mL or less, such as about 120 mCi/mL or less, such as about 100 mCi/mL or less, such as about 80 mCi/mL or less, such as about 60 mCi/mL or less, such as about 40 mCi/mL or less, such as about 20 mCi/mL or less.

In some aspects, a liquid inlet channel stream and/or a liquid outlet channel stream may have a pressure from about 0 Pa to about 100 Pa, including all increments of 1 Pa therebetween. For instance, a liquid inlet channel stream and/or a liquid outlet channel stream may have a pressure of about 0 Pa or more, such as about 10 Pa or more, such as about 20 Pa or more, such as about 30 Pa or more, such as about 40 Pa or more, such as about 50 Pa or more, such as about 60 Pa or more, such as about 70 Pa or more, such as about 80 Pa or more, such as about 90 Pa or more. In general, a liquid inlet channel stream and/or a liquid outlet channel stream may have a pressure of about 100 Pa or less, such as about 90 Pa or less, such as about 80 Pa or less, such as about 70 Pa or less, such as about 60 Pa or less, such as about 50 Pa or less, such as about 40 Pa or less, such as about 30 Pa or less, such as about 20 Pa or less, such as about 10 Pa or less. Notably, when the flow pattern of a channel includes liquid droplets, an increase in pressure may increase the rate of generation of liquid droplets and/or may decrease the average liquid droplet diameter.

Notably, in one aspect, a liquid inlet channel stream and/or a liquid outlet channel stream may comprise a caustic solution. In general, the caustic solution may comprise sodium hydroxide and/or sodium sulfate. For instance, the caustic solution may have a sodium hydroxide concentration of about 0 mol/L or more, such as about 5 mol/L or more, such as about 10 mol/L or more, such as about 15 mol/L or more, such as about 20 mol/L or more, such as about 25 mol/L or more. In general, the caustic solution may have a sodium hydroxide concentration of about 50 moL/L or less, such as about 40 moL/L or less, such as about 30 moL/L or less, such as about 25 moL/L or less, such as about 20 moL/L or less, such as about 15 moL/L or less, such as about 10 moL/L or less, such as about 5 moL/L or less. Generally, the caustic solution may have a sodium sulfate concentration of about 0 mg/mL or more, such as about 25 mg/mL or more, such as about 50 mg/mL or more, such as about 75 mg/mL or more, such as about 100 mg/mL or more, such as about 125 mg/mL or more, such as about 150 mg/mL or more, such as about 175 mg/mL or more, such as about 200 mg/mL or more, such as about 225 mg/mL or more. In general, the caustic solution may have a sodium sulfate concentration of about 300 mg/mL or less, such as about 250 mg/mL or less, such as about 225 mg/mL or less, such as about 200 mg/mL or less, such as about 175 mg/mL or less, such as about 150 mg/mL or less, such as about 125 mg/mL or less, such as about 100 mg/mL or less, such as about 75 mg/mL or less, such as about 50 mg/mL or less, such as about 25 mg/mL or less.

### Target Activation

In general, a microfluidic device formed in accordance with the present disclosure may be included in a system that utilizes target activation for the separation and purification of one or more radioisotopes. For instance, a target material, such as a foil, rod, or disk, may be placed in a first container in a nuclear reactor. Then, the target material may be irradiated via neurons or other particles (e.g., protons, alpha particles). Notably, the exposure of the target material to a high flux of neurons or other particles may result in the transformation of one or more stable isotopes in the target material to one or more radioisotopes. Next, the one or more radioisotopes may be positioned or placed in a second container, such as a quartz crucible. Then, the second container may be positioned or placed in a third container. Notably, the third container may include a coil that can be heated (i.e., a heater coil), such as a copper coil. Additionally or alternatively, a coil may be wrapped around the third container. Next, the coil may be heated to a temperature from about 700° C. to about 800° C., including all increments of 1° C. therebetween. For instance, the coil may be heated to a temperature of about 700° C. or more, such as about 720° C. or more, such as about 740° C. or more, such as about 760° C. or more, such as about 780° C. or more. In general, the coil may be heated to a temperature of about 800° C. or less, such as about 780° C. or less, such as about 760° C. or less, such as about 740° C. or less, such as about 720° C. or less.

Then, an inlet air supply may be provided to the third container such that air flows around the crucible and through the third container. The air of the inlet air supply may be provided at a flow rate from about 10 mL/min to about 50 mL/min, including all increments of 1 mL/min or more. For instance, the air of the inlet air supply may be provided at a flow rate of about 10 mL/min or more, such as about 20 mL/min or more, such as about 30 mL/min or more, such as about 40 mL/min or more. In general, the air of the inlet air supply may be provided at a flow rate of about 50 mL/min or less, such as about 40 mL/min or less, such as about 30 mL/min or less, such as about 20 mL/min or less. Notably, the air may be utilized to carry or transport one or more radioisotopes and/or remaining target material to one or more filters (e.g., a silver charcoal filter) and/or one or more traps (e.g., one or more caustic traps, one or more tellurium coil traps). A filter and/or a trap may be utilized to capture or filter out at least some solids and/or other impurities, such as TeO₂. Alternatively, a filter or trap may be utilized to filter or trap a radioisotope. Notably, a caustic trap may include a caustic solution containing sodium hydroxide and/or sodium sulfate. After the at least partial separation of a radioisotope from solids and/or other impurities, the radioisotope may be stored for transport in a fourth container.

In one aspect, target activation may be utilized to produce I-131. For instance, TeO₂ powder, which is the target material in this aspect, may be inserted into an aluminum container and irradiated in a nuclear reactor via neutrons. The neutron flux utilized to irradiate the TeO₂ powder may be about 5×10¹³ n/m²s for about 21 days. Then, the TeO₂ powder, which now includes I-131, may be positioned or placed in a quartz crucible. Then, the quartz crucible may be positioned or placed in a flask wrapped in a copper coil. The copper coil may then be heated to a temperature of about 750° C. Next, an inlet air supply may be supplied to the flask such that air flows around the crucible and through the flask at a flow rate of about 20 mL/min to about 30 mL/min. The air may contain I-131 and residual TeO₂. Then, the air may be filtered through one or more caustic traps. A caustic trap, for instance, may contain about 8 mL caustic solution of 0.1 mol/L sodium hydroxide and about 0.2 mg/mL of sodium sulfate. A caustic trap may capture the I-131 via liquid-gas extraction. Next, the I-131 may be prepped for storage and placed in a storage container.

Notably, as previously disclosed herein, a microfluidic device formed in accordance with the present disclosure may be incorporated into a system that utilizes target activation. For instance, a microfluidic device in accordance with the present disclosure may replace one or more filters and/or one or more traps of the aforementioned system. In this respect, a microfluidic device formed in accordance with the present disclosure may be used to purify a gas or a liquid containing a radioisotope. For instance, air may be utilized to carry or transport one or more radioisotopes and/or remaining target material to one or more microfluidic devices. The one or more microfluidic devices may be utilized to capture or filter out at least some solids and/or other impurities. In some aspects, the one or more microfluidic devices may be utilized to capture or filter out a radioisotope.

### Fission Method

In general, a microfluidic device formed in accordance with the present disclosure may be included in a system that utilizes a fission method for the separation and purification of one or more radioisotopes. For instance, a target material, such as a foil, rod, or disk, may be placed in a nuclear reactor. Notably, the target material may be a clad target material, such as an aluminum clad target material. Then, the target material may be irradiated via neurons or other particles (e.g., protons, alpha particles). Notably, the exposure of the target material to a high flux of neurons or other particles may result in the transformation of one or more stable isotopes in the target material to one or more radioisotopes. Next, the target material and/or one or more radioisotopes may be positioned or placed in a second container and dissolved in a caustic solution, such as a solution containing sodium hydroxide. Then, the one or more radioisotopes may be captured or filtered via one or more resin columns by liquid-solid extraction. Next, an elution solution may be used to separate the one or more radioisotopes from a resin column. Then, the elution solution may be concentrated, purified, and/or filtered into a final product containing a radioisotope. In general, the one or more resin columns may be cleaned with a cleaning solution, such as a cleaning solution comprising acetone and/or ethanol after the one or more radioisotopes are removed via the elution solution.

Notably, as previously disclosed herein, a microfluidic device formed in accordance with the present disclosure may be incorporated into a system that utilizes the fission method. For instance, a microfluidic device in accordance with the present disclosure may replace the one or more resin columns. For instance, one or more microfluidic devices may contain one or more resin columns that capture or filter one or more radioisotopes. Notably, the ability of the microfluidic device to be readily removed and replaced with another microfluidic device from the system may shorten or eliminate the cleaning time typically associated with cleaning resin columns. Further, the microfluidic device may be sealed or capped after one or more radioisotopes are captured in the resin of a microfluidic device. In this respect, an elution solution may not be utilized in the process of purifying the one or more radioisotopes before the packaging and/or shipping of the one or more radioisotopes. Alternatively, an elution solution can be injected or pumped into the microfluidic device, followed by the sealing or capping of the microfluidic device. Notably, Mo-99 may be captured in a resin of a microfluidic device.

### Multiple Hot Cell Configuration

In general, a microfluidic device formed in accordance with the present disclosure may be included in a system for the separation and purification of one or more radioisotopes that uses two or more hot cells in a multiple hot cell configuration. In this respect, a system in accordance with the present disclosure may include two or more hot cells in fluid communication. In general, one or more components (e.g., a microfluidic device) of one or more hot cells may be in fluid communication. For instance, a first hot cell may include one or more containers (e.g., one or more flasks, one or more crucibles) and/or one or more coils (e.g., one or more heater coils, one or more tellurium trap coils). The first hot cell may be in fluid communication with a second hot cell. The second hot cell may include one or more microfluidic devices, one or more coils (e.g., one or more heater coils, one or more tellurium trap coils), and/or one or more filters. The second hot cell may be in fluid communication with a third hot cell. The third hot cell may include one or more filters and/or packaging.

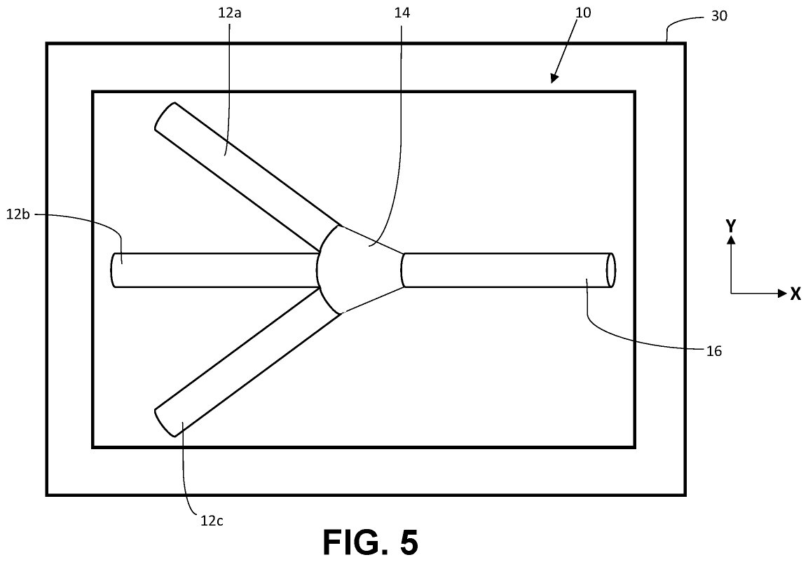

In general, a hot cell in accordance with the present disclosure may include one or more microfluidic devices, one or more containers, one or more coils, one or more filters, one or more traps, or a combination thereof. Notably, as illustrated in FIG. 5, a microfluidic device 10 may be incorporated into a hot cell 30.

### Process Controls

Generally, as previously disclosed herein, a microfluidic device formed in accordance with the present disclosure may be included in a system for separating and purifying one or more radioisotopes. Notably, the system may include a process control device that monitors process parameters such as the concentration, temperature, flow rate, and pressure of one or more inlet channel streams and/or one or more outlet channel streams of a microfluidic device. In general, the monitoring of the concentration level(s) of sodium hydroxide and/or sodium sulfate in one or more inlet channel streams and/or one or more outlet channel streams may be particularly significant. For instance, the concentration level of sodium hydroxide and/or sodium sulfate in one or more inlet channel streams and/or one or more outlet channel streams may affect the product purity of a radioisotope and/or may affect the degradation or corrosion of the microfluidic device. In general, the temperature of a coil, such as a copper coil, may be monitored such that materials located in a crucible, such as a target material and/or one or more radioisotopes, are steadily evaporated. The temperature of the coil may at least partially determine the temperature of a stream carrying the radioisotope to and/or in a microfluidic device. In some aspects, an inlet channel stream and/or an outlet channel stream may be monitored for their respective pressure by monitoring the pressure of the stream(s) entering a microfluidic device and/or exiting a microfluidic device. A process control device may be used to determine the pressure drop across a microfluidic device.

Notably, a system formed in accordance with the present disclosure may include a monitoring system that may include artificial intelligence, machine learning, optimization, and design of experiments where process parameters (e.g., the purity of the radioisotope, size of droplets, etc.) are monitored and other parameters (temperature, flow rates, etc.) are readjusted. The data utilized by the monitoring system may include data from previous experiments, simulations, modeling, or a combination thereof.

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

1. A microfluidic device comprising:
two or more inlet channels, a first inlet channel of the two or more inlet channels having a first inlet channel junction angle of from about 10° to about 90°, the first inlet channel having a channel width of less than about 1 millimeter, the two or more inlet channels comprising two or more inlet channel streams, at least one inlet channel stream comprising one or more radioisotopes;
an outlet channel, the outlet channel comprising an outlet channel stream; and
a junction, the junction being in fluid communication with the two or more inlet channels and the outlet channel;
wherein the two or more inlet channels are in fluid communication with the outlet channel.

2. The microfluidic device of claim 1, wherein the one or more radioisotopes are non-PET radioisotopes.

3. The microfluidic device of claim 1, wherein the first inlet channel has a channel width of greater than 1 micron.

4. The microfluidic device of claim 1, wherein the outlet channel has a throat width of from about 1 micron to about 1 millimeter.

5. The microfluidic device of claim 1, wherein at least one inlet channel has an inlet channel width, wherein the outlet channel has a throat width, wherein the ratio of the inlet channel width to the outlet channel throat width is greater than about 1:1.

6. The microfluidic device of claim 1, wherein at least one inlet channel is cylindrical.

7. The microfluidic device of claim 1, wherein the outlet channel stream has a flow pattern comprising a plurality of droplets of a liquid.

8. The microfluidic device of claim 7, wherein the plurality of droplets has a liquid droplet size from about 1 micron to about 150 microns.

9. The microfluidic device of claim 1, wherein the microfluidic device comprises a second inlet channel, the second inlet channel having a second inlet channel junction angle of from about 10° to about 90°.

10. The microfluidic device of claim 1, wherein the microfluidic device comprises a second inlet channel, the second inlet channel having a second inlet channel junction angle, wherein the first inlet channel junction angle and the second inlet channel junction angle are within 70° of each other.

11. The microfluidic device of claim 1, wherein the microfluidic device comprises a second inlet channel, the second inlet channel having a second inlet channel junction angle, wherein the first inlet channel junction angle and the second inlet channel junction angle are within 40° of each other.

12. The microfluidic device of claim 1, wherein the two or more inlet channel streams comprise a first inlet channel stream, the first inlet channel stream having a flow rate from about 0.01 μL/min to about 20 mL/min.

13. A microfluidic device comprising:
two or more inlet channels, the two or more inlet channels comprising a first inlet channel, the first inlet channel having a channel width of less than about 1 millimeter, the two or more inlet channels comprising two or more inlet channel streams, the two or more inlet channel streams comprising a first inlet channel stream, the first inlet channel stream comprising a liquid, the two or more inlet channel streams comprising a second inlet channel stream, the second inlet channel stream comprising a gas, wherein at least one inlet channel stream comprises one or more radioisotopes;
an outlet channel, the outlet channel comprising an outlet channel stream; and
a junction, the junction being in fluid communication with the two or more inlet channels and the outlet channel;
wherein the two or more inlet channels are in fluid communication with the outlet channel.

14. The microfluidic device of claim 13, wherein the liquid of the first inlet channel stream comprises sodium hydroxide.

15. The microfluidic device of claim 13, wherein the liquid of the first inlet channel stream comprises sodium sulfate.

16. The microfluidic device of claim 13, wherein the gas of the second inlet channel stream comprises the one or more radioisotopes.

17. The microfluidic device of claim 13, wherein the two or more inlet channel streams comprise a third inlet channel stream.

18. A system for separating and purifying radioisotopes comprising:
a hot cell comprising one or more microfluidic devices, the one or more microfluidic devices comprising:
two or more inlet channels, the two or more inlet channels comprising a first inlet channel, the first inlet channel having a channel width of less than about 1 millimeter, the two or more inlet channels comprising two or more inlet channel streams, the two or more inlet channel streams comprising a first inlet channel stream;
one or more outlet channels, the one or more outlet channels comprising one or more outlet channel streams, the one or more outlet channel streams comprising a first outlet channel stream; and
a junction; the junction being in fluid communication with the two or more inlet channels and the one or more outlet channels.

19. The system of claim 18, wherein the first inlet channel stream comprises a liquid.

20. The system of claim 18, wherein the first outlet channel stream has a flow pattern comprising a plurality of droplets comprising a liquid.
